(19) United States
(12) Patent Application Publication
(10) Pub. No.: US 2009/0073326 A1
(43) Pub. Date: Mar. 19, 2009

(54) ROTATABLE BUILT-IN SYSTEM OF IMAGE-SOUND ISNTALLATION

(76) Inventor: Woo-Sick Jang, Seoul (KR)

Correspondence Address: SNELL & WILMER L.L.P. (Main), 400 EAST VAN BUREN, ONE ARIZONA CENTER, PHOENIX, AZ, 85004-2202, US

(21) Appl. No.: 11/719,681

(22) PCT Filed: Nov. 8, 2005
(86) PCT No.: PCT/KR05/03768

§ 371 Date: May 18, 2007

(30) Foreign Application Priority Data
Nov. 19, 2004 (KR) 20-2004-0032761

(51) Int. Cl. H04N 5/64

(52) U.S. Cl. 348/836; 348/E05.128

(57) ABSTRACT

Disclosed is a rotatable built-in system for rotatably installing an image-sound installation, such as a TV or a home theater, through a wall so that viewers at both sides of the wall can watch the image-sound installation. The rotatable built-in system includes the image-sound installation comprising a TV; a support frame for supporting the image-sound installation; a wall frame surrounding the circumference of the support frame so that the support frame is rotatably installed on the wall frame; a rotating unit for rotating the support frame to a front regular position or a rear regular position against the wall frame; and a wall body, through which an installation hole along which the wall frame is fixedly installed is formed, wherein viewers at both sides of the wall body can watch the image-sound installation by means of the rotation of the support frame to the front regular position or the rear regular position by the rotating unit.

### CROSS-REFERENCE TO RELATED APPLICATIONS

This application is a U.S. national phase filing under 35 U.S.C. §371 of PCT/KR2005/003768 filed Nov. 8, 2005 and claims priority from Korean Application No. 20-2004-0032761, which was filed on Nov. 19, 2004.

### TECHNICAL FIELD

The present invention relates to a rotatable built-in system of an image-sound installation, and more particularly to a rotatable built-in system for rotatably installing an image-sound installation through a wall so that viewers at both sides of the wall can watch the image-sound installation.

### BACKGROUND OF THE INVENTION

In general, TVs serving as typical image-sound installations used at home have been developed from traditional cathode ray tube TVs to large-sized projection TVs, and further to high-quality PDP or LCD TVs. Home theater systems for allowing viewers to listen to stereophonic sound of TV broadcasts and DVDs have been gradually propagated.

Generally, the above image-sound installations, such as TVs or home theaters, are placed on a mount disposed at a location close to the wall of a living room or a bedroom. Otherwise, slim TVs, such as wall-mounted PDP or LCD TVs, are hung on a position of the wall having an appropriate height.

Compared to the cathode ray tube TVs or the projection TVs, the PDP TVs or the LCD TVs have high resolution and small thickness, thus having a wall-mounted structure occupying a narrow indoor space. However, the PDP TVs or the LCD TVs are considerably expensive, and thus currently the propagation of the PDP TVs or the LCD TVs is slow.

That is, although the slim TVs or home theaters including the same are updated digital image-sound systems having high quality, the propagation of the slim TVs or the home theaters is slow due to their high costs. Accordingly, in order to effectively use the above updated digital image-sound systems, it is preferable that the utility of the systems is increased.

Further, when the new-generation digital TVs have a computer function, the above digital TVs serve as a server of a home network, or at least as a center of the home network. Moreover, when the new-generation digital TVs are connected to a digital moving picture communication device, the above digital TVs serve also as a monitor for remote medical examination and treatment or picture communication by telephone.

### SUMMARY OF THE INVENTION

### Technical Problem

Therefore, the present invention has been made in view of the above problems, and it is an object of the present invention to provide a rotatable built-in system of an image-sound installation in which the utility of the image-sound installation widely used at home is improved.

### Technical Solution

In accordance with an aspect of the present invention, the above and other objects can be accomplished by the provision of a rotatable built-in system of an image-sound installation comprising:

the image-sound installation comprising a TV;

a support frame for supporting the image-sound installation;

a wall frame surrounding the circumference of the support frame so that the support frame is rotatably installed on the wall frame;

a rotating unit for rotating the support frame to a front regular position or a rear regular position against the wall frame; and

a wall body, through which an installation hole along which the wall frame is fixedly installed is formed,

wherein viewers at both sides of the wall body can watch the image-sound installation by means of the rotation of the support frame to the front regular position or the rear regular position by the rotating unit.

Preferably, the rotating unit may comprise a rotary shaft serving as a center of rotation for rotating the support frame against the wall frame, a driven gear connected to the rotary shaft, a driving gear connected to the driven gear, a motor for rotating the driving gear, and a controller for controlling the regular and reverse directional rotation and the stopped position of the motor.

### ADVANTAGEOUS EFFECTS

The rotatable built-in system of an image-sound installation in accordance with the present invention rotatably installs the image-sound installation in the installation hole formed through the wall body so that viewers at both side spaces (for example, a living room and a bedroom) centering on the wall body can watch the image-sound installation only by installing one set of the image-sound installation in the wall body, thereby increasing the utility of the image-sound installation.

When the image-sound installation is connected to a digital moving picture communication device and is used as a monitor for remote medical examination and treatment or picture communication by telephone, the rotatable built-in system of the present invention allows a patient or a communicating person to turn the image-sound installation towards a place in which the patient or the communicating person exists without the patient or the communicating person's movement directly to a place in which the image-sound installation is installed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view of a rotatable built-in system of an image-sound installation in accordance with an embodiment of the present invention; and

FIG. 2 is a view illustrating the operation of the rotatable built-in system of the image-sound installation in accordance with the embodiment of the present invention.

### DETAILED DESCRIPTION

Now, a preferred embodiment of the present invention will be described in detail with reference to the annexed drawings. This embodiment exemplarily described the present invention, but does not limit the scope of the present invention.

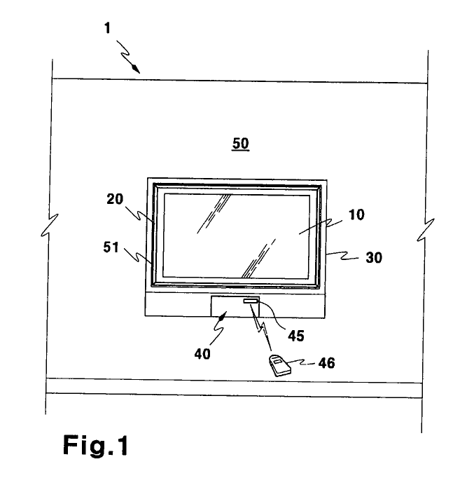

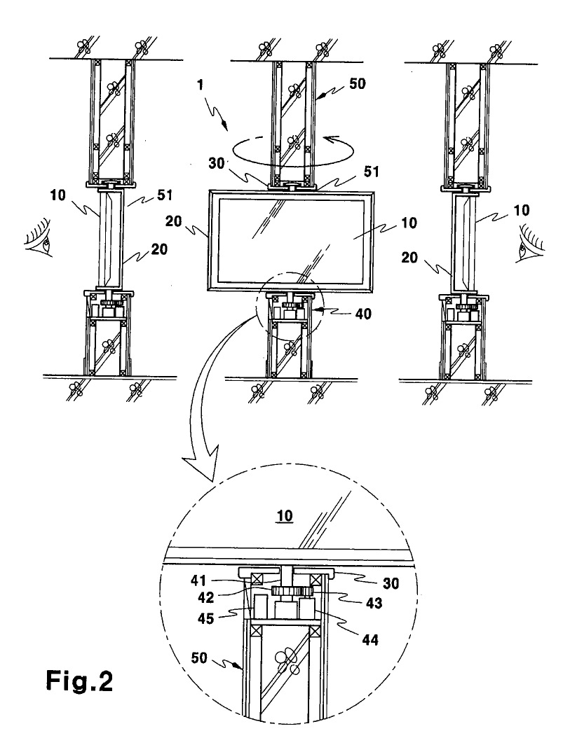

As shown in FIGS. 1 and 2, a rotatable built-in system 1 of an image-sound installation in accordance with the preferred embodiment of the present invention comprises an image-sound installation 10, a support frame 20, a wall frame 30, a rotating unit 40, and a wall body 50.

The image-sound installation 10 denotes a slime TV, such as a PDP TV or an LCD TV, or a home theater or a home server including such a TV. Hereinafter, the image-sound installation 10 is a slim TV.

The reason why the slim TV other than a cathode ray tube TV or a projection TV is used as the image-sound installation 10 applied to the system 1 of the present invention is that the wall body 50 of the system 1 has a structure for containing the image-sound installation 10 therein and only the slim TV can be installed in the wall body 50 having a designated thickness (for example, 150 mm). Accordingly, if the wall body 50 has a large thickness or a cathode ray tube TV or a projection TV having a smaller thickness is developed, those skilled in the art will appreciate that other elements except for the slim TV may be applied to the system 1 of the present invention.

The support frame 20 supports the image-sound installation 10 so that the image-sound installation 10 can be rotatably installed on the wall frame 30, thus being rotated together with the rotation of the image-sound installation 10.

In the preferred embodiment of the present invention, the slim TV is used as the image-sound installation 10, and the support frame 20 completely surrounds the circumference of the image-sound installation 10. Those skilled in the art will appreciate that a main body (for example, an amplifier) and a speaker of the image-sound installation 10 are rotated together with the rotation of the slim TV or the system 1 of the present invention comprises other elements rotated separately from the slim TV.

The wall frame 30 is fixedly installed along the circumference of an installation hole 51 formed through the wall body 50. The wall frame 30 encircles the circumference of the support frame 20, thus rotatably containing the support frame 20. That is, the image-sound installation 10 is rotatably installed on the inside of the wall frame 30 under the condition that the image-sound installation 10 is fixed to the support frame 20.

The rotation and fixation of the support frame 20 against the wall frame 30 is achieved by the rotating unit 40. Any unit, which rotates the support frame 20 by user's manipulation so that the image-sound installation 10 can be stopped at a front regular position or a rear regular position, may be used as the rotating unit 40. Generally known power transmission units, such as a rotary shaft, a motor, and a gear, may be used as the rotating unit 40.

In this embodiment of the present invention, the rotating unit 40 comprises a rotary shaft 41 used as a center of rotation for rotating the support frame 20 against the wall frame 30, a driven gear 42 connected to the rotary shaft 41, a driving gear 43 connected to the driven gear 42 at an appropriate deceleration rate, a motor (for example, a regular and reverse directional stepping motor) 44 for rotating the driving gear 43, a controller 45 for controlling the regular and reverse directional rotation and the stopped position of the motor 44, and a remote controller 46 for remotely controlling the controller 45. The remote controller 46 may be omitted.

The above structure of the rotating unit 40 describes a basic principle for rotating the image-sound installation 10 located in the installation hole 51 of the wall body 50. The rotating unit 40 may have other structures by combining known various mechanical, electrical, and electronic techniques.

The system 1 of the present invention serves to install the image-sound installation 10 in the wall body 50. Thus, the system 1 of the present invention comprises the wall body 50, and the installation hole 51 for fixing the wall frame 30 is formed through the wall body 50.

In the above-described system 1 of the present invention, the installation hole 51 is formed through the wall body 50 (for example, a wall body for forming the boundary between a living room and a bedroom), the wall frame 30 is installed along the installation hole 51, and the rotating unit 40 is installed on the support frame 20 under the condition that the support frame 20 having the image-sound installation 10 installed thereon is inserted into the wall frame 30. The rotating unit 40 is manipulated so that the image-sound installation 10 faces the living room or the bedroom, thereby allowing the image-sound installation 10 to be selectively watched by viewers in the living room and the bedroom.

In the case that the system 1 of the present invention is used for remote medical examination and treatment or picture communication by telephone, a patient or a communicating person doesn't need to move to a place in which the image-sound installation 10 is installed, but may use the system 1 of the present invention in a place (for example, a bedroom) in which the patient or the communicating person stays. Particularly, a patient restricted in his/her movement can conveniently use the system 1 of the present invention.

The built-in system 1 of the present invention may be applied to existing buildings. Preferably, the built-in system 1 of the present invention is optionally applied to common houses, such as apartments, from a design step of the construction of the houses.

Sound absorption between two spaces having the wall body 50 interposed therebetween is an important problem of the built-in system 1 of the present invention. In order to solve the above sound absorption problem, it is preferable that the support frame 20 has a size fitted to the wall frame 30 within the limit of not obstructing the rotation of the support frame 20, thereby maximally sealing a gap between the outer circumference of the support frame 20 and the inner circumference of the wall frame 30.

In order to achieve firm sound insulation, mechanical sound insulating devices, which block the gap between the support frame 20 and the wall frame 30 when the support frame 20 is located at a correct position, are installed on the support frame 20 and/or the wall frame 30.

Sound insulating curtains (doors) are installed above the system 1 of the present invention at both sides of the wall body 50. The sound insulating curtains are closed when the image-sound installation 10 is not used or turn towards the reverse direction, thereby preventing the exposure of the system 1 to the outside and exhibiting good sound insulation effects.

Further, a structure for adjusting the viewing height of the image-sound installation 10 by vertically adjusting the height of the support frame 20 against the wall frame 30, or a structure for adjusting the viewing angle of the image-sound installation 10 by adjusting the angle of inclination of the support frame 20 against the wall frame 30 may be employed by the system 1 of the present invention.

1. A rotatable built-in system of an image-sound installation comprising:
the image-sound installation comprising a TV;
a support frame for supporting the image-sound installation;
a wall frame surrounding the circumference of the support frame so that the support frame is rotatably installed on the wall frame;
a rotating unit for rotating the support frame to a front regular position or a rear regular position against the wall frame; and
a wall body, through which an installation hole along which the wall frame is fixedly installed is formed,
wherein viewers at both sides of the wall body can watch the image-sound installation by means of the rotation of the support frame to the front regular position or the rear regular position by the rotating unit.

2. The rotatable built-in system as set forth in claim 1, wherein the rotating unit comprises:
a rotary shaft serving as a center of rotation for rotating the support frame against the wall frame;
a driven gear connected to the rotary shaft;
a driving gear connected to the driven gear;
a motor for rotating the driving gear; and
a controller for controlling the regular and reverse directional rotation and the stopped position of the motor.
